(19) United States
(12) Patent Application Publication
(10) Pub. No.: US 2022/0318118 A1
(43) Pub. Date: Oct. 6, 2022

(54) DETECTING CHANGES IN APPLICATION BEHAVIOR USING ANOMALY CORROBORATION

(71) Applicant: HEWLETT PACKARD ENTERPRISE DEVELOPMENT LP, Houston, TX (US)

(72) Inventors: DAVID NELLINGER ADAMSON, San Jose, CA (US); GUOLI SUN, San Jose, CA (US)

(21) Appl. No.: 17/218,649

(22) Filed: Mar. 31, 2021

(51) Int. Cl. G06F 11/34; G06F 11/14

(52) U.S. Cl. CPC G06F 11/3419; G06F 11/1451; G06F 11/1458; G06F 11/3466

(57) ABSTRACT

Unexpected changes in application behavior are detected using time series telemetry in a manner that minimizes the upfront knowledge needed about the time series measurements themselves. A univariate analysis is performed on a set of operational metrics to identify anomalous signals indicative of potential anomalous events. A multivariate analysis is then performed to corroborate anomalous signals across groupings of metrics and to thereby determine that the anomalous signals correspond to an anomalous event. A boundary of the anomalous event is determined and the anomalous event is characterized based on a clustering of previously identified incidents. One or more participating entities are then determined for the anomalous event and a narrative description of the anomalous event is generated and presented to an end user. The narrative description identifies, among other things, the characterization of the anomalous event, a predicted cause of the anomalous event, and the participating entities.

### DESCRIPTION OF RELATED ART

The behavior of a computing system or a computing environment can vary over time and can be assessed based on various metrics that characterize aspects of that behavior. In some cases, a computing system may exhibit periodic changes in its behavior that form part of an expected pattern of behavior. For instance, a system may undergo periodic backups during which various operational metrics may change due to activity associated with the backups. As an example, a sharp increase in read activity may be observed during the backups. In other cases, rogue activity such as a ransomware attack may cause various operational metrics to trigger outside their normal ranges.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a block diagram depicting a pipeline of computing engines configured to execute anomaly corroboration processing to detect anomalous events within a computing environment according to example embodiments of the disclosed technology.

FIG. 2 depicts a hybrid data flow and block diagram illustrating data movement among the various engines of the pipeline of FIG. 1 as part of the anomaly corroboration processing according to example embodiments of the disclosed technology.

FIG. 3 depicts a set of executable instructions stored in machine-readable storage media that, when executed, cause an illustrative anomaly corroboration method to be performed to detect, analyze, and descriptively inform an end user of anomalous events within a computing environment according to example embodiments of the disclosed technology.

FIG. 4 depicts raw time series data for individual operational metrics that indicates potential anomalous events according to example embodiments of the disclosed technology.

FIG. 5 depicts an example precision-recall curve according to example embodiments of the disclosed technology.

FIG. 6A is a flowchart illustrating a univariate analysis stage of anomaly corroboration processing according to example embodiments of the disclosed technology.

FIG. 6B depicts data plots indicative of example results of the univariate analysis according to example embodiments of the disclosed technology.

FIG. 7A depicts plots of time series data for two different example operational metrics that are assessed during a multivariate stage of anomaly corroboration processing to corroborate an anomalous event according to example embodiments of the disclosed technology.

FIG. 7B depicts anomalous event corroboration with respect to different trigger event thresholds according to example embodiments of the disclosed technology.

FIG. 8 depicts a plot of time series data for an operational metric that indicates the presence of contextually related anomalous events according to example embodiments of the disclosed technology.

FIG. 9 depicts a plot of operational metric data that illustrates a boundary identification stage of anomaly corroboration processing according to example embodiments of the disclosed technology.

FIG. 10 depicts categorization of corroborated anomalous events into cluster groups according to example embodiments of the disclosed technology.

FIG. 11 depicts an example narrative card according to example embodiments of the disclosed technology.

FIG. 12 schematically depicts performing anomaly corroboration processing on a stack slice that includes peers at multiple system layers according to example embodiments of the disclosed technology.

FIG. 13 is an example computing component that may be used to implement various features of example embodiments of the disclosed technology.

The figures are not exhaustive and do not limit the present disclosure to the precise form disclosed.

### DETAILED DESCRIPTION

Unexpected changes in application behavior can indicate any of a variety of serious issues ranging from performance degradation to service downtime to a security breach such as a ransomware attack. Changes in various metrics that characterize aspects of an application's behavior can occur as a result of such unexpected changes in the application's behavior. However, the values of individual metrics considered in isolation cannot provide predictive or descriptive insight into the potential causes for metrics registering unexpected values. Example embodiments of the disclosed technology relate to, among other things, systems, methods, computer-readable media, techniques, and methodologies for detecting unexpected changes in application behavior using time series telemetry in a manner that minimizes the upfront knowledge needed about the time series measurements themselves. As a result, the approaches disclosed herein are highly extensible and can be applied to new applications as their telemetry data becomes available. Moreover, the approaches disclosed herein can be applied to new types of telemetry data (e.g., new metrics) “out-of-the-box” without requiring upfront knowledge of the metrics.

This extensibility that allows embodiments of the disclosed technology to be applied to new applications and new types of telemetry data without requiring extensive a priori domain-specific knowledge constitutes a technical improvement over conventional solutions, which instead require extensive training of machine learning (ML) classifiers on the telemetry data in order to monitor for anomalous behavior. Further, example embodiments of the disclosed technology implement a modular pipeline according to which identification/detection of anomalous events is separated from the interpretation of those events. In this manner, unsupervised learning can be applied to interpret the detected anomalous events because the number of detected events would be substantially less than the number of data points in the time series data that is analyzed to identify the anomalous events. While, in example embodiments, some specific insights regarding the detected anomalous events may require use of trained classifiers, many do not and rather can be achieved through unsupervised learning. As such, example embodiments of the disclosed technology provide a technical solution to the technical problem faced by conventional solutions that use trained classifiers to detect anomalous events.

Example embodiments of the disclosed technology execute anomaly corroboration processing on telemetry data to detect and evaluate anomalous events. The anomaly corroboration processing includes an operation pipeline that begins with a univariate analysis performed on individual time series data for each of several operational metrics. As used herein, operational metric refers to any metric capable of being sensed by a physical sensor, measured by a digital sensor, or calculated algorithmically. Operational metrics may include, without limitation, user input/output related metrics, performance/resource consumption related metrics, or the like. An operational metric may also be referred to herein interchangeably as an information technology (IT) metric, a computing metric, or the like.

The univariate analysis may, individually with respect to each metric of a set of operational metrics, compare current time series data for the metric to historical time series data for the metric to determine if any anomalous signals are present in the current time series data. An anomalous signal may refer to any unexpected behavior in time series data for a metric. More specifically, an anomalous signal may refer to a metric value that is outside of an expected range such as above or below a threshold value. For instance, an anomalous signal may be an unidentified workload that is exhibiting a high level of read/write activity (i.e., above a threshold value representative of an expected value for the metric). As another non-limiting example, an anomalous signal may be the absence of expected activity (e.g., below a threshold value representative of an expected value for the metric). As will be described in more detail later in this disclosure, an unexpected workload may be determined, based on both a multivariate corroborative analysis as well as further downstream processing, to be indicative of a rogue event, while the absence of expected activity can point to application downtime.

The output of the univariate analysis (i.e., anomalous signals identified from the individual time series data) is provided as input to the multivariate analysis stage, during which the anomalous signals are corroborated and scores that quantify an overall significance of anomalous activity for several groupings of metrics at a particular point in time are generated. The groupings of metrics may be defined based on the similarity of the types of metrics (e.g., performance counters, error counters, etc.) as well as based on the interconnectedness of the components (e.g., all of the metrics related to a particular virtual machine and the services on which it depends). In example embodiments, the multivariate stage includes evaluating various threshold criteria to score the anomalous signals identified by the univariate analysis to determine if the signals are in fact representative of an anomalous event. The threshold criteria may include, without limitation, whether at least a threshold number of metrics are exhibiting anomalous signals, whether a cumulative deviation of the metrics exhibiting the anomalous signals exceeds a threshold value, and so forth. In some embodiments, different metrics may be weighted differently when generating a score that indicates the extent to which anomalous signals associated with individual metrics are corroborated.

In a third stage of the anomaly corroboration pipeline, boundaries of an anomalous event may be determined. Determining the boundaries of an anomalous event may include determining an onset and a termination of the anomalous behavior. In some embodiments, multiple anomalistic incidents that are within a predetermined temporal distance from one another (i.e., all occur within a predetermined timeframe) may be treated as a single anomalous event for the purposes of generating a narrative description thereof and informing an end user. More specifically, the multiple anomalistic incidents may be determined to have a same predicted cause (e.g., ransomware attack, service downtime, etc.), and thus, may be consolidated as a single anomalous event reported to an end user.

In a next stage of the anomaly corroboration pipeline, the anomalous event may be characterized. Characterizing the anomalous event may include determining which cluster group the anomalous event belongs to among an initial clustering of previously identified incidents. Example cluster groups include, without limitation, expected write-heavy workload missing, expected read-heavy workload missing, unexpected write-heavy workload, unexpected read-heavy workload, unexpected extended copy (xcopy) workload, potential ransomware attack, or the like. Classifying the anomalous event allows for specific messaging to be provided to an end user regarding specific interventions that can be pursued. For instance, a user's response to an increase in high bandwidth data copy activity represented by increases in offloaded data transfer (odx) and extended copy (xcopy) traffic would differ from detection of a possible ransomware attack represented by increases in user I/O and a sharp decline in compressibility of inbound data.

In example embodiments, a next stage of the anomaly corroboration processing pipeline involves identifying participating entities/peers associated with the anomalous event. Participating entities may include virtual machines, storage volumes, etc. that are experiencing the anomalous activity. Then, an ensemble of messaging rules may be applied to construct a narrative description of the anomalous event, which may be presented to an end user such as a system administrator. In some embodiments, the narrative description may be provided in real-time or near real-time as current time series metric data is collected and analyzed, thereby allowing the system administrator to take remedial measures early on to mitigate the impact of the anomalous event on the computing environment. For instance, measures can be taken to isolate and push back a rogue attack such as a ransomware attack to mitigate damage from the attack. In some embodiments, prior to generating a narrative description of an anomalous event and presenting the narrative description to an end user, a relevancy of the event to an end user may be determined based, for example, on a trained machine learning (ML) classifier. The ML classifier may be trained on user feedback that indicates the usefulness of previous narrative descriptions of anomalous events.

In some embodiments, the anomaly detection system (e.g., the system that executes the anomaly corroboration pipeline) may take automatic remedial action in response to a detected and corroborated anomalous event. Such automatic remedial action may be taken in lieu of or in addition to providing a narrative indication of characteristics of the anomalous event. The automatic remedial action that is taken may vary based on the type of anomalous event that is detected. For example, upon detecting a likely ransomware attack, the anomaly detection system may signal a storage device or backup service to: i) alter its protocol with respect to backups (e.g., retaining snapshots and other backups for a longer period of time that what is typically done, requiring a “cool-off” period before deleting any backups, etc.) and/or ii) quarantine particular hosts to prevent them from writing data to one or more storage devices. As another non-limiting example, in the case of a system outage (e.g., the absence of expected system/application behavior), the anomaly detection system may signal a host or application to perform a failover to a backup instance of the host or application to restore service function. As yet another non-limiting example, if previously unidentified system activity is detected and the new activity is impacting expected system workloads, the anomaly detection system may signal a storage device, host, or application to throttle resource consumption of the workload until an end user review of the source of the activity is completed.

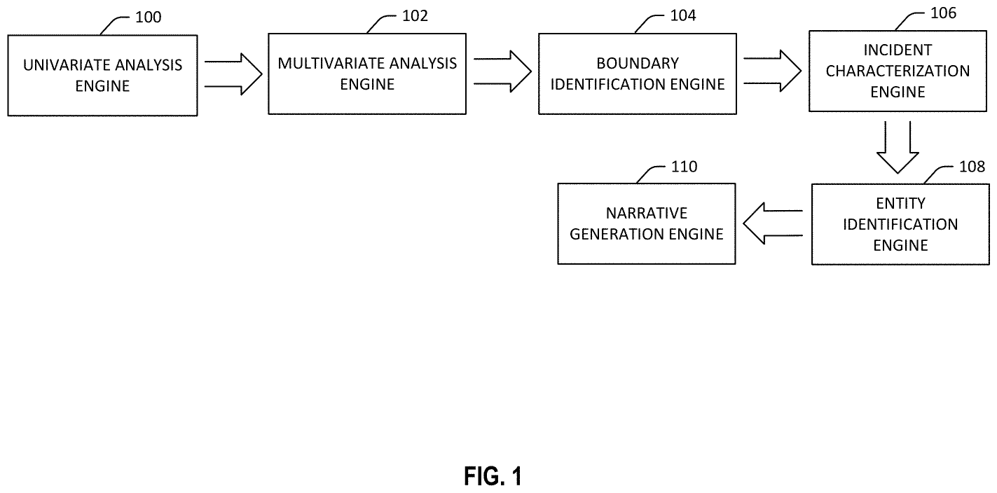

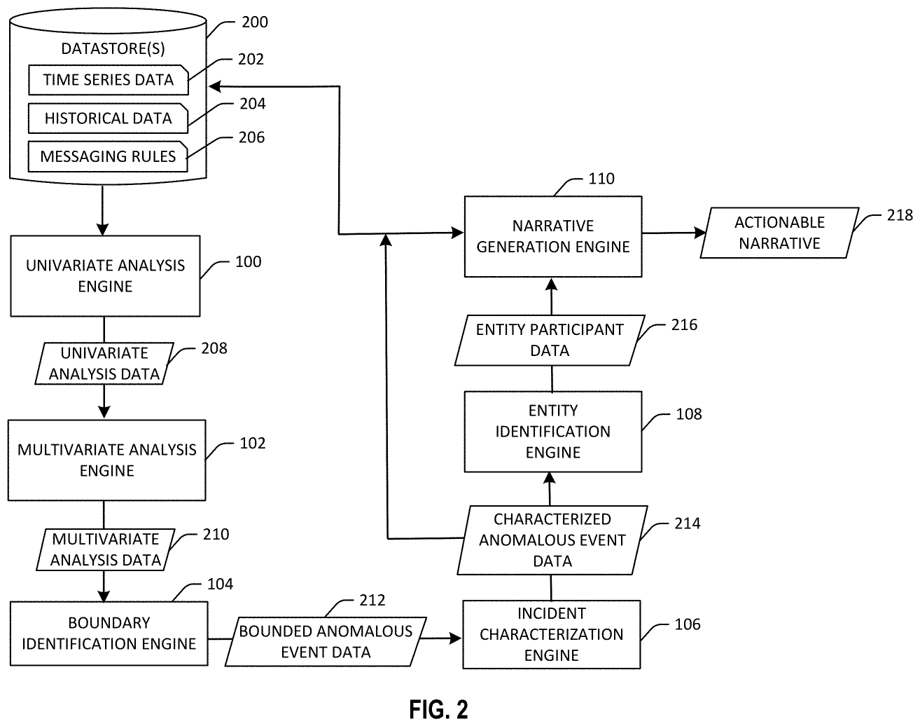

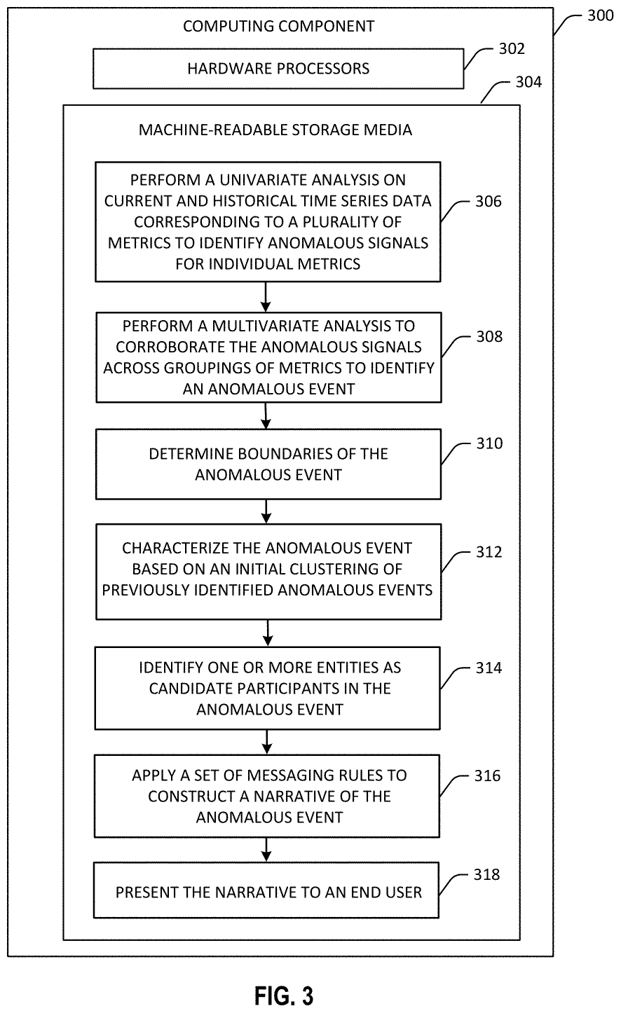

FIG. 1 depicts example computing engines of an analysis pipeline for executing anomaly corroboration processing according to example embodiments of the disclosed technology. FIG. 2 depicts a hybrid data flow and block diagram illustrating data movement among the various engines of the pipeline of FIG. 1 as part of the anomaly corroboration processing according to example embodiments of the disclosed technology. FIG. 3 depicts a computing component 300 that includes one or more hardware processors 302 and machine-readable storage media 304 storing a set of machine-readable/machine-executable instructions that, when executed, cause the hardware processors 302 to perform an anomaly corroboration method according to example embodiments of the disclosed technology. FIGS. 1, 2, and 3 will be described in conjunction with one another hereinafter while also referring to the other Figures.

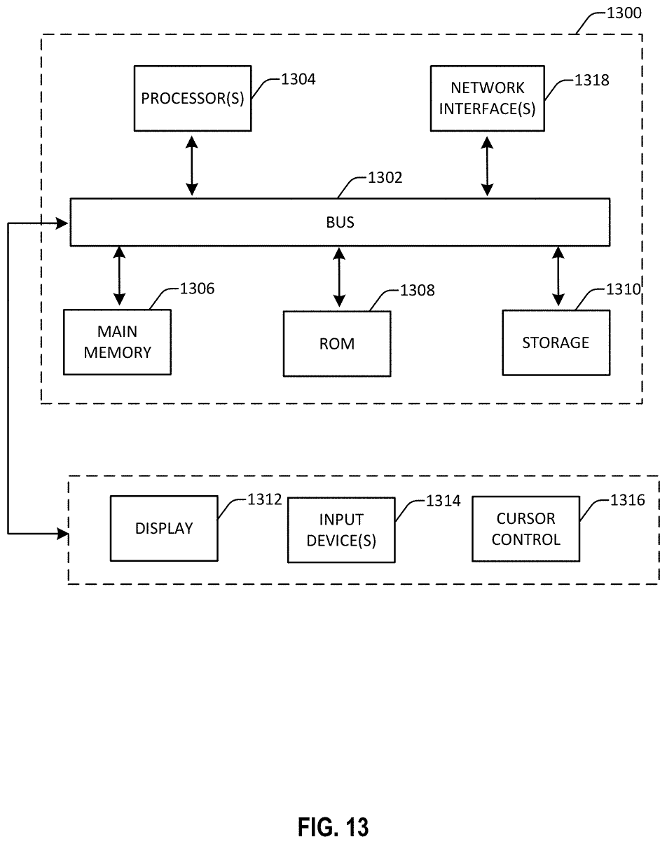

In example embodiments, the machine-readable storage media 304 depicted in FIG. 3 may include any other suitable machine-readable storage media described herein including any of the memory or data storage depicted in FIG. 13. The instructions depicted in FIG. 3 as being stored on the machine-readable storage media 304 may be modularized into one or more computing engines such as those depicted in FIGS. 1 and 2. In particular, each such computing engine may include a corresponding subset of the machine-readable and machine-executable instructions depicted in FIG. 3, such that when executed by the hardware processors 302, the instructions cause the hardware processors 302 to perform corresponding tasks/processing. In example embodiments, the set of tasks performed responsive to execution of the set of instructions forming part of a particular computing engine may be a set of specialized/customized tasks for effectuating a particular type/scope of processing.

In example embodiments, the computing component 300 depicted in FIG. 3 may be, for example, the computing system 1300 depicted in FIG. 13, or another computing device described herein. In some example embodiments, the computing component 300 may be a desktop computer; a laptop computer; a tablet computer/device; a smartphone; a personal digital assistant (PDA); a wearable computing device; or the like. In other example embodiments, the computing component 300 may be a server, a server cluster, or the like. In still other example embodiments, the computing component 300 may be a customized computing device or chip including, without limitation, a field programmable gate array (FPGA), an application specific integrated circuit (ASIC), a programmable logic controller (PLC), a programmable logic array (PLA), or the like.

The hardware processors 302 may include, for example, the processor(s) 1304 depicted in FIG. 13. In particular, the hardware processors 302 may include any suitable type of processing unit including, but not limited to, a central processing unit (CPU), a microprocessor, a Reduced Instruction Set Computer (RISC) microprocessor, a Complex Instruction Set Computer (CISC) microprocessor, a microcontroller, a System-on-a-Chip (SoC), a digital signal processor (DSP), an ASIC, an FPGA, a PLC, a PLA, and so forth. In some example embodiments, a single integrated device may constitute the computing component 300, the hardware processors 302, and the machine-readable storage media 304. For example, an ASIC, FPGA, a SOC, or the like may be the computing component 300 that also includes the hardware processors 302 for executing logic that is hardwired into the device and/or instructions stored in the storage media 304.

In example embodiments, the hardware processors 302 (or any other processing unit described herein) are configured to execute the various computing engines depicted in FIGS. 1 and 2, which in turn, are configured to provide corresponding functionality in connection with anomaly corroboration processing. In particular, the hardware processors 302 may be configured to execute various computing engines forming part of the anomalous event detection and interpretation pipeline depicted in FIG. 1. The pipeline includes a univariate analysis engine 100, a multivariate analysis engine 102, a boundary identification engine 104, an incident characterization engine 106, an entity identification engine 108, and a narrative generation engine 110. Each of these computing engines may be configured, responsive to execution by the hardware processors 302, to perform specialized tasks/processing in connection the detection and interpretation of anomalous events as disclosed herein. Operations performed responsive to execution of machine-executable instructions of a computing engine may be described herein at times as being performed by the engine itself.

Referring now to FIG. 3 in conjunction with FIG. 2, at block 306, machine-executable instructions of the univariate analysis engine 100 may be executed by the hardware processors 302 to cause a univariate analysis to be performed on current time series data 202 and historical time series data 204. The current time series data 202 and the historical time series data 204 may correspond to a set of operational metrics that monitor various aspects of an application's behavior. The time series data may be generated by various sensors which may include physical sensors (e.g., a temperature sensor to measure heat generated by a CPU), digital sensors that measure digital metrics (e.g., CPU utilization), and so forth. The current time series data 202 and the historical time series data 204 may be stored in and retrieved from one or more datastore(s) 200. The time series data may be captured periodically at any desired periodicity (e.g., every millisecond, every second, every minute, etc.). Example metrics for which time series data may be captured include, for example, user input/output (I/O) related metrics such as compressibility of incoming data, read-write balance of incoming data, absolute magnitude of incoming data, amount of uncompressed data that accumulates overtime, and so forth. Example metrics may further include performance resource consumption metrics such as CPU utilization, memory utilization, read-write activity, and so forth, which may be relevant to service downtime and/or rogue workload related use cases. Example metrics may further include data replication rate, network transmission/reception metrics, or the like. More generally, the metrics analyzed at the univariate analysis stage may include any metric that reflects some aspect of load on the system.

In some example embodiments, the univariate analysis engine 100 may be configured to slice the time series data into different temporal bins representing, for example, different hours of a day or different days of a week to provide additional context when analyzing the time series data across a lookback window. For instance, when comparing the current time series data 200 to the historical time series data 202, the univariate analysis engine 100 may compare current time series data corresponding to a particular day and time (e.g., Monday 9 AM) to historical time series data corresponding to the same time slice over a selected lookback window (e.g., the past 4 weeks). By doing so, the univariate analysis engine 100 can distinguish anomalous signals that may indicate an actual anomalous event from periodic behavior which, while deviating from more typical behavior of application/system, nonetheless constitutes expected behavior due to the recurring pattern that it demonstrates. For instance, a number of monitored metrics have a strong weekly periodicity such as daily or weekly data backups. In example embodiments, the lookback window may include at least multiple weeks of time series data to ensure that periodic behavior patterns are accounted for. In addition, in example embodiments, different time slices of a lookback window may be assigned different weights reflecting the relative importance of the time slice to the univariate analysis. For example, more recent time slices in the lookback window may be weighted more heavily.

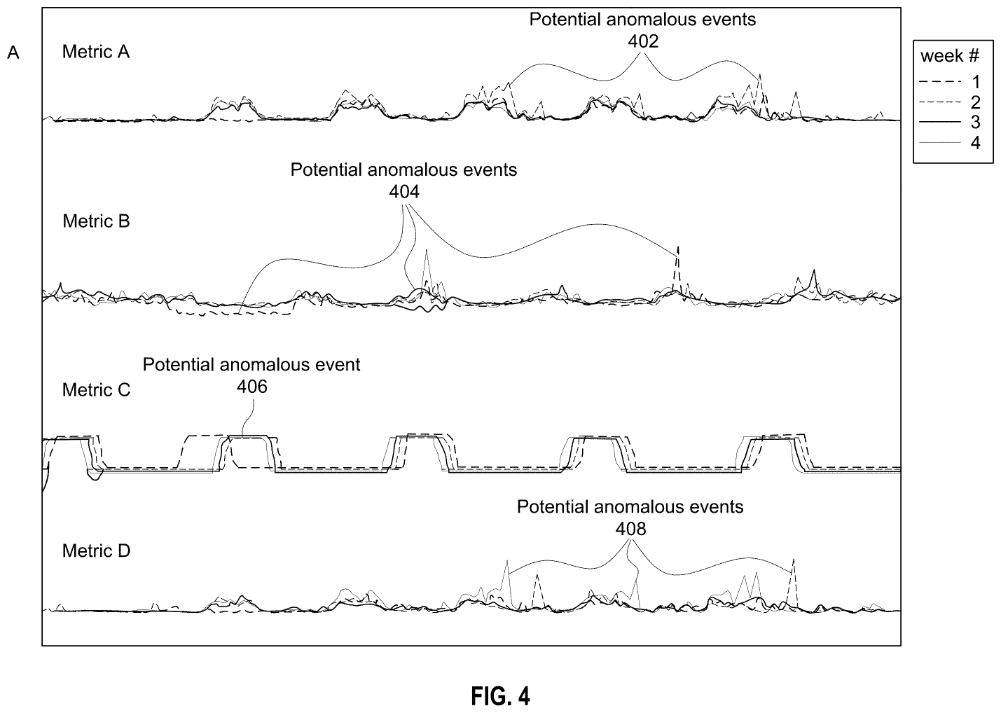

FIG. 4 depicts raw time series data that indicates potential anomalous events for various operational metrics according to example embodiments of the disclosed technology. As depicted in FIG. 4, the raw time series data is plotted for each of multiple metrics (metrics A-D) for each week of a lookback window that includes several weeks. In example embodiments, the univariate analysis is performed on the metrics A-D at block 306 (FIG. 3) to reveal various anomalous signals which are indicative of potential anomalous events. For instance, the univariate analysis may indicate potential anomalous events 402 for metric A, potential anomalous events 404 for metric B, potential anomalous events 406 for metric C, and potential anomalous events 408 for metric D. In some embodiments, the anomalous signals may occur in the current time series data 202, as is the case for potential anomalous events 402 and 408, for example. In other example embodiments, the anomalous signals may occur in prior time slices of the lookback window (e.g., in the historical time series data 204), as depicted for metric B, for example. Of interest in FIG. 4, across metrics A, B, C and D, is the loss (metrics A, B, and D) and shift of activity (metric C) that coincides towards the beginning of all four time series for the same week.

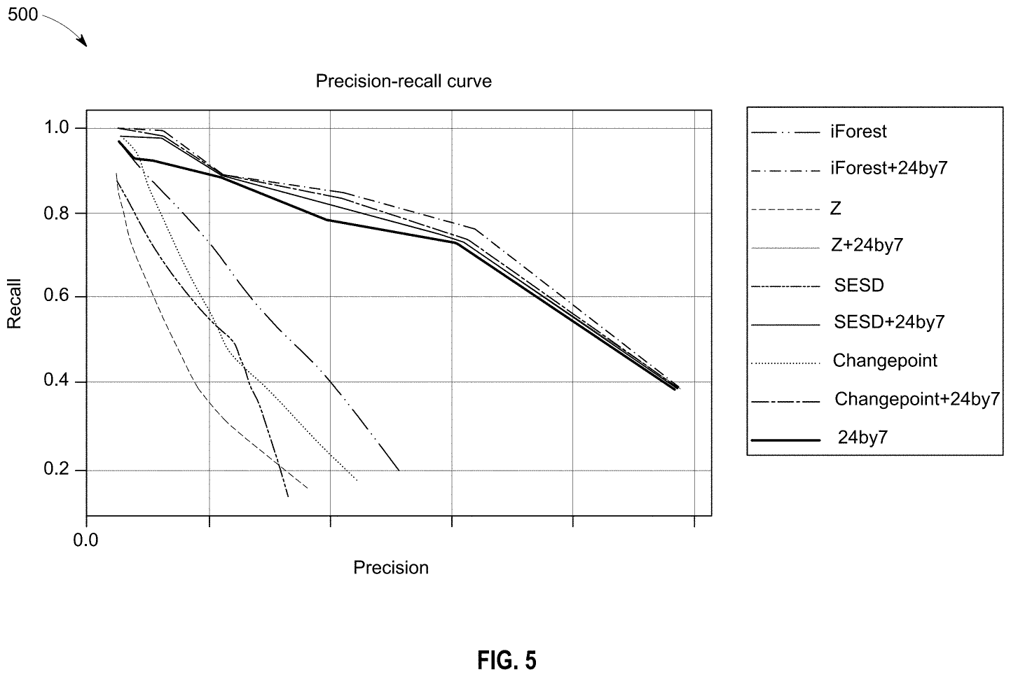

FIG. 5 depicts an example precision-recall curve 500 that depicts the recall and precision performance for various statistical methods that may be employed at the univariate analysis, multivariate corroboration, or incident evaluation stages. In example embodiments, recall may refer to the ability of the analysis to identify anomalous signals relating to all actual anomalous events, and precision may refer to the proportion of events flagged as being anomalous that are in fact actual anomalous events. As shown in FIG. 5, both the recall and the precision of various statistical univariate analysis methods are improved when the time slice approach described earlier is employed according to which time series data associated with the same time slice (e.g., Wednesday at 8 AM) is compared across multiple weeks of a lookback window, for example. Example embodiments of the disclosed technology that rely on a univariate analysis followed by a corroborative multivariate analysis, improve recall without sacrificing precision as compared to existing methodologies that use a multivariate classifier for each timepoint. In particular, labeled data supervised learning produces classifier results with good precision but poor recall because the coverage space is limited by the scope of the labeled data.

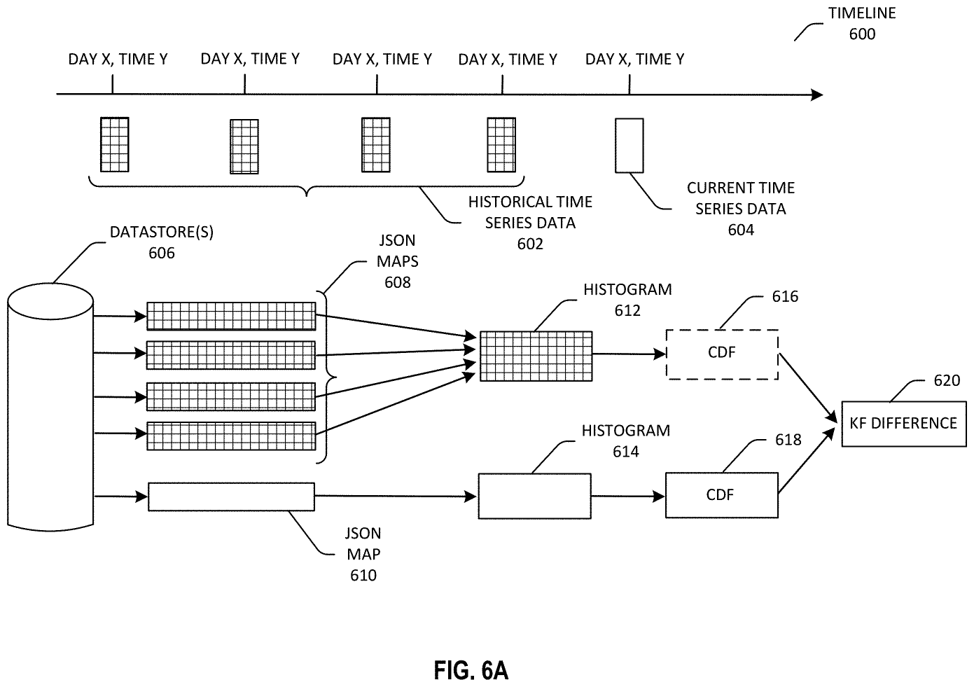

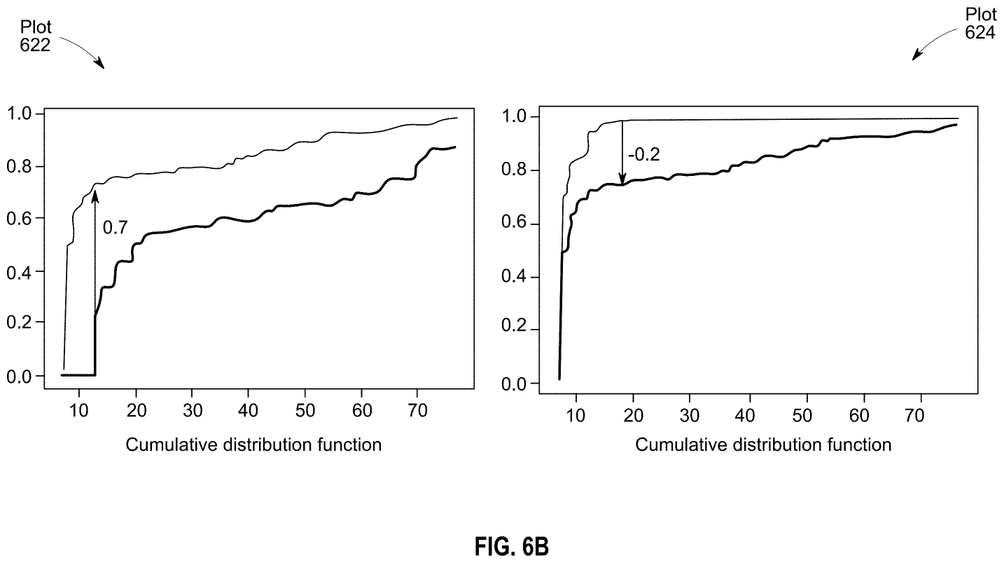

FIG. 6A is a flowchart illustrating the univariate analysis performed at block 306 in more detail. As depicted in FIG. 6A, current time series 604 corresponding to a particular time slice (Day X, Time Y) is compared against historical time series data 602 corresponding to the same time splice. The amount of historical time series data 602 considered may depend on the size of the lookback window 600 that is selected. In example embodiments, the current time series data 604 and the historical time series data 602 may be stored in and retrieved from one or more datastores 606. The univariate analysis engine 100 may generate maps 608 from the historical time series data 602 and a map 610 from the current time series data 604. In example embodiments, the maps 608 and the map 610 may contain nested data and may be Javascript Object Notation (JSON) maps, Avro maps, or any other format that accommodates nested content. The univariate analysis engine 100 may then generate a histogram 612 representative of the JSON maps 608 and a histogram 614 representative of the JSON map 610. The univariate analysis engine 100 may then determine a cumulative distribution function (CDF) 616 from the histogram 612 and a CDF 618 from the histogram 614. The univariate analysis engine 100 may determine a Kolmogorov-Smirnov (KS)-based difference 620 between the CDF 618 and the CDF 616. The KS-based difference 620 may be a variation of the formal definition of the KS distance that is modified to preserve sign. Broadly speaking, the KS-based difference 620 is a statistical measure of the deviation between current values for a metric (i.e., the current time series data 604) and expected values for the metric, as embodied by the historical time series data 602. More formally, a KS difference is the largest absolute difference between two distribution functions (e.g., CDF 616 and CDF 618) across all x values, and in some embodiments, the modified KS-based difference 620 is the largest signed difference between two distribution functions (e.g., CDF 616 and CDF 618) across all x values. It should be appreciated that the KS-based difference 620 is merely an example statistical measure that can be used and that other statistical methods/measures are within the scope of this disclosure including, without limitation, the Kullback-Leibler divergence, the Wilcoxon-Mann-Whitney test, or the like.

FIG. 6B depicts graphically how the modified KS-based difference used in various embodiments of the disclosed technology accounts for the sign of the difference between distribution functions. For instance, plot 622 on the left indicates a positive KS-based difference, while plot 624 on the right indicates a negative KS-based difference. A positive KS-based difference may indicate that the current values of a metric are greater than historical values. Conversely, a negative KS-based difference may indicate that current values of a metric are below historical values. In some embodiments, the univariate analysis engine 100 may determine that a metric is exhibiting an anomalous signal if an absolute value of the KF difference for the metric exceeds a threshold value.

Referring again to FIG. 3, the univariate analysis engine 100 may generate univariate analysis data 208 at block 306. The univariate analysis data 208 may include an indication of those individual metrics that exhibit anomalous signals and the time frame over which the anomalous signals are observed. The univariate analysis data 208 may be provided as input to the multivariate analysis engine 102. At block 308, machine-executable instructions of the multivariate analysis engine 100 may be executed by the hardware processors 302 to cause the multivariate analysis engine 102 to perform a multivariate analysis to corroborate the anomalous signals identified in the univariate analysis data 208 across groupings of metrics. Corroborating the anomalous signals with respect to multiple related metrics may indicate (or at a minimum increase the likelihood) that the anomalous signals are indicative of an actual anomalous event. The groupings of metrics may be defined based on the similarity of the types of metrics as well as based on the interconnectedness of the components.

In example embodiments, the multivariate analysis performed at block 308 includes evaluating a set of metrics against various threshold criteria to score the anomalous signals identified in the univariate analysis data 208 to determine if the signals are in fact representative of an anomalous event. The threshold criteria may include, without limitation, whether at least a threshold number of metrics are exhibiting anomalous signals, whether a cumulative deviation of the metrics exhibiting the anomalous signals exceeds a threshold value, whether a cumulative deviation of only those metrics exhibiting anomalous signals that individually exceed a first threshold value, itself exceeds a second threshold value, and so forth. In some embodiments, different metrics may be weighted differently when generating a score that indicates the extent to which anomalous signals associated with individual metrics are corroborated.

In some embodiments, metrics may be associated with expert-curated “tags” that enhance the meaningfulness of the anomaly detection and reduce the rate of false positives. In some embodiments, the tags may indicate which raw metrics measure similar behavior. A non-limiting example of a tag is “solid state drive (SSD) utilization”—which may include raw sensors such as ssd_iops, ssd_mbps, ssd_active_milliseconds_per_minute, ssd_queue_depth and average vs. max versions of the same over a set of SSD drives. In example embodiments, a representative metric may be selected from each different metric type (as indicated by the tags associated with metrics) to form the set of metrics that is evaluated to corroborate anomalous signals observed with respect to one or more metrics. For example, a single representative metric may be selected from the set of metrics that includes the “ssd” tag, and a representative metric may be similarly selected for each of one or more other different metric types. In particular, metrics of the same type tend to exhibit corroborating signals more often because these metrics are naturally correlated. Instead, by considering, during the multivariate analysis and based on associated metadata tags, metrics that are known to represent different functions of the system or the IT stack, the likelihood of discovering more meaningful anomalous incidents increases. Moreover, the use of such metadata tags leverages the domain knowledge that is likely to be known up front while still minimizing reliance on a large corpus of real-world data and/or human-labeled incidents of interest.

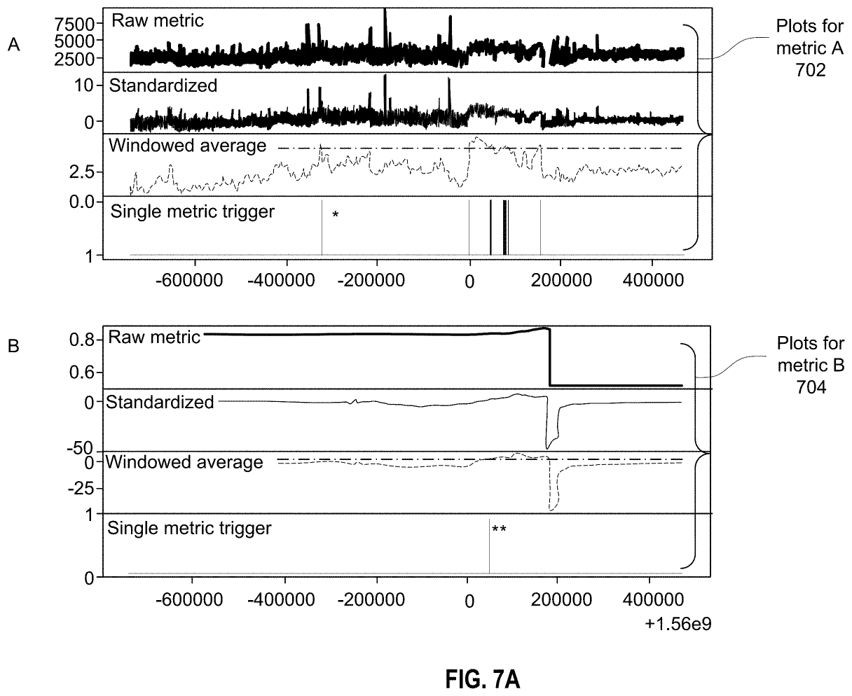

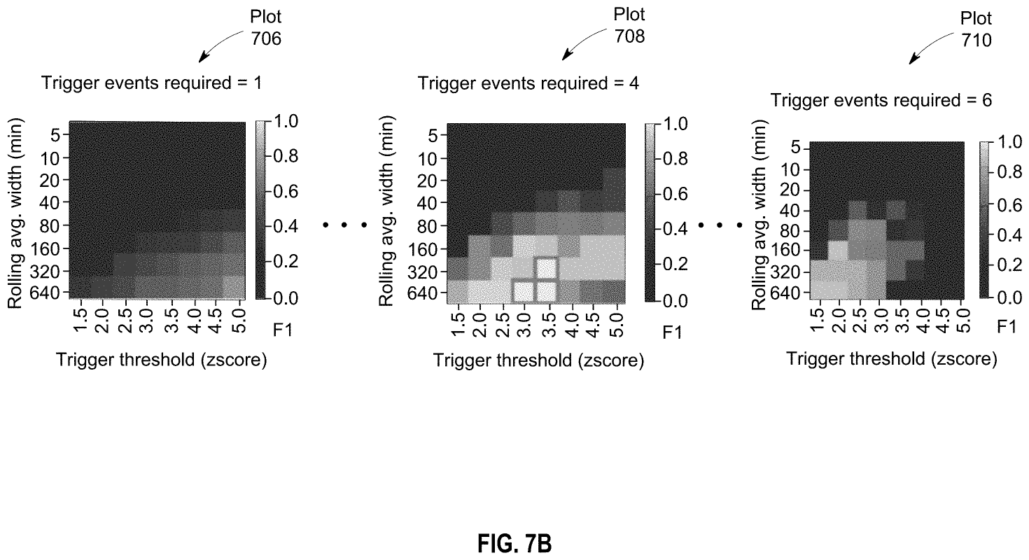

FIG. 7A depicts plots of time series data for two example metrics—metric A and metric B. Metrics A and B may belong to a same grouping of metrics based on type, interconnectedness of components whose behavior the metrics measure, or the like. The plots 702 for metric A include a plot of the raw time series data, a plot of the standardized time series data, a windowed average plot, and a plot that illustrates a trigger of the metric when the value of the metric exceeds the windowed average. FIG. 7A includes similar plots for metric B. The gray shaded region represented a known ransomware attack, and thus, an event of genuine interest. In the plots for metric A 702, the peak with the single asterisk represents a false positive, which is not corroborated by an anomalous signal associated with metric B during the same time slice. On the other hand, the peak with the double asterisk in the plots for metric B 704 represents a corroborating positive event in a separate time series than the time series for metric A, which helps to corroborate the true positives in the gray shaded region of the time series for metric A.

FIG. 7B depicts different plots corresponding to different trigger event requirements. The various trigger event requirements may refer to the number of metrics within a grouping of related metrics that must exhibit anomalous signals (e.g., deviate from expected behavior by more than a threshold amount) for the multivariate analysis engine 102 to identify the anomalous signals as an anomalous event. FIG. 7B depicts three example plots that respectively correspond to different trigger event requirements. Plot 706 corresponds to a trigger event requirement of 1, plot 708 corresponds to a trigger event requirement of 4, and plot 710 corresponds to a trigger event requirement of 6. That is, plot 706 corresponds to a scenario in which only a single metric is required to trigger (i.e., exhibit an anomalous signal) for an anomalous event to be identified; plot 708 corresponds to a scenario in which 4 metrics are required to trigger; and plot 710 corresponds to a scenario in which 6 events are required to trigger.

Each of the plots 706, 708, and 710 plot rolling average on the y-axis and a trigger threshold (zscore) on the x-axis. For each trigger threshold at a given rolling average, a corresponding score (e.g., F1 score) is determined. In some embodiments, the F1 score quantifies detection of a set of known ransomware attacks using a set of 10 distinct metrics. The F1 score indicates the level of recall and precision associated with a trigger threshold for a given rolling average. An F1 score of 1 indicates an ideal level of precision and recall. As depicted in FIG. 7B, for a trigger event requirement of 1, no trigger threshold produces an F1 score that indicates both highest recall and highest precision. At a trigger requirement of 4, however, various trigger thresholds now produce F1 scores indicative of the highest level of recall and precision. Then, at the higher trigger requirement of 6, again no trigger threshold produces an F1 score that indicates the highest level of recall and precision. This indicates that as more metrics are required to trigger in order to corroborate an anomalous event, the precision and recall initially increases up to a certain point, but then begins to diminish again as the trigger event requirement becomes too high. In particular, if the trigger event requirement is too low, then recall may be high as most (if not all) anomalous events will be detected, but precision is likely to be low because false anomalous events are likely to be identified. On the other hand, if the trigger event requirement is too high, precision may be high because of the number of metrics that are required to trigger in order to identify an anomalous event, but recall is likely to be low as the high trigger event requirement is likely to cause various anomalous events to be missed. Thus, in order to obtain a high degree of recall and precision during the multivariate analysis stage, in some embodiments, the trigger event requirement should be greater than 1 but less some integer X. These detection requirements can be fit using only a small number of real-world examples and do not require prohibitively large sets of training data. Further, the above-described F1 score is merely an example way to quantify anomaly detection and other quantifiers/scores may be used.

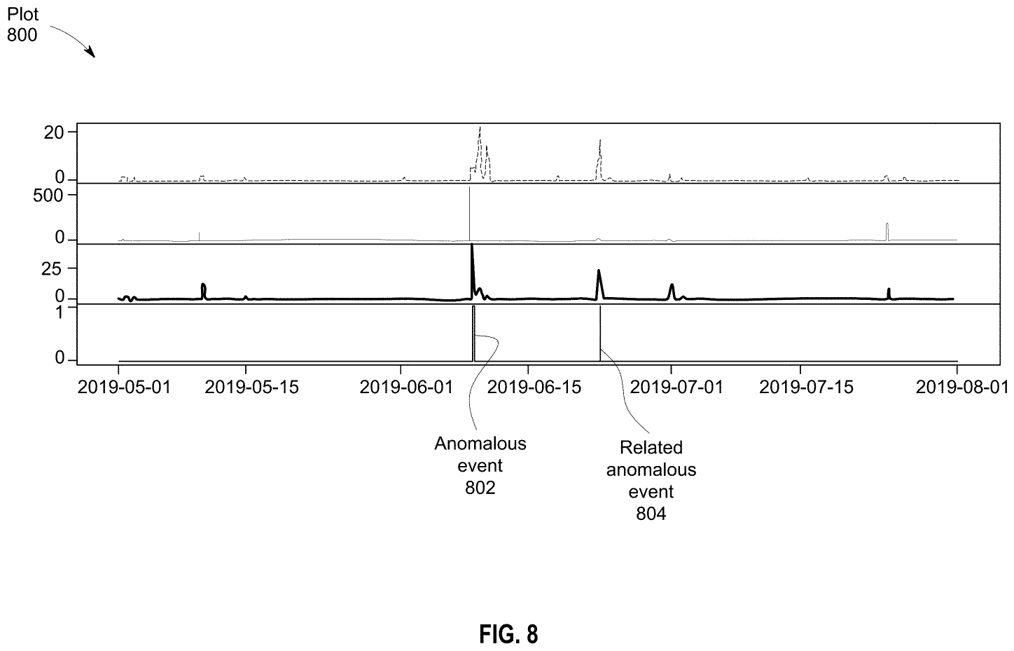

FIG. 8 depicts a plot of time series data for an operational metric that indicates the presence of contextually related anomalous events according to example embodiments of the disclosed technology. In example embodiments, as the number of metrics considered during the multivariate analysis stage increases, new anomalous events that otherwise may not have been identified become apparent. For instance, in plot 800 of time series data, an anomalous event 804 may be determined to be contextually related to another anomalous event 802. The anomalous event 802 may represent, for example, a ransomware attack, while the anomalous event 804 may represent an xcopy operation that includes heightened read/write activity that occurs after the ransomware attack. The xcopy operation may correspond, for example, a system administrator recovering lost data from a backup location or performing additional backups to further secure the attacked data after the ransomware attack. Alternatively, the xcopy operation may be correspond to a rogue actor attempting to cover its tracks after the ransomware attack.

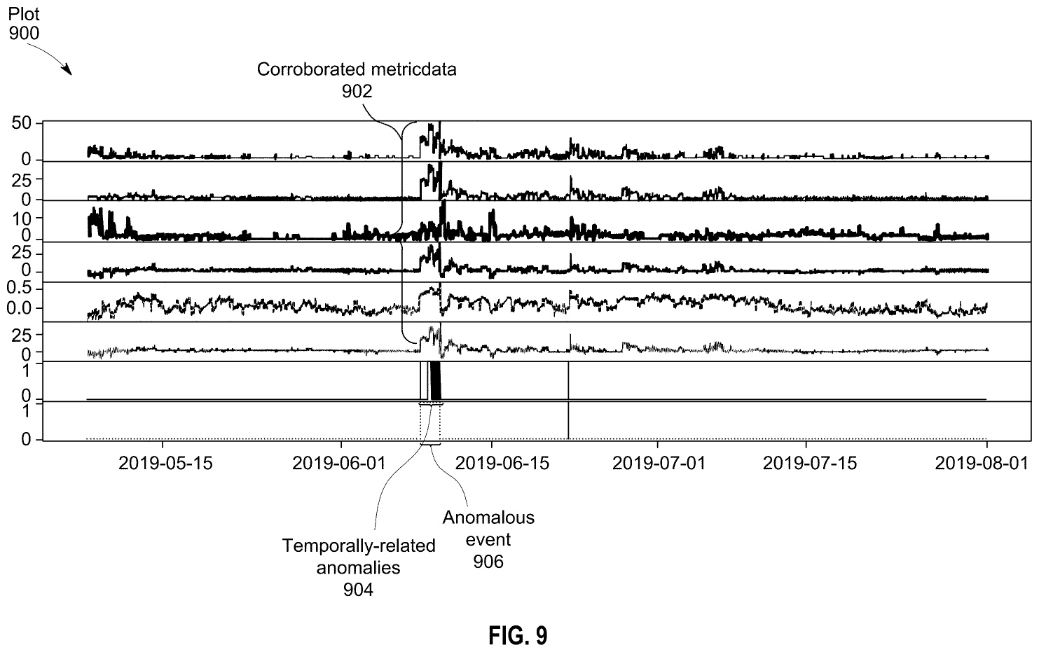

Referring again to FIG. 3, at block 310, machine-executable instructions of the boundary identification engine 104 may be executed by the hardware processors 302 to cause the boundary identification engine 104 to receive multivariate analysis data 210 as input and to determine the boundaries of an anomalous event identified in the multivariate analysis data 210. Determining the boundaries of an anomalous event may include determining an onset and a termination of the activity identified as the anomalous event. FIG. 9 depicts boundary identification according to example embodiments of the disclosed technology. As the plot 900 shows, metric 902 data relating to a grouping of related metrics may be corroborated in accordance with any of a variety of threshold corroborative criteria. In some embodiments, the corroborated metric data 902 may indicate a series of temporally-related anomalies 904. The temporally-related anomalies 904 may be identified as being within a threshold temporal distance of each other. In some embodiments, the boundary identification engine 104 may apply a smoothing function that consolidates the multiple anomalies 904 into a single reportable anomalous event 906. The boundary identification engine 104 may then determine the time period over which the anomalous event occurs as the same as the time period over the collection of temporally-related anomalies 904 occurs. This streamlines the reporting of the anomalous event 906 to an end user. The boundary identification engine 104 may generate bounded anomalous event data 212 that indicates the boundaries of the anomalous event detected by the multivariate analysis engine 102 and may provide the bounded anomalous event data 212 as input to the incident characterization engine 106.

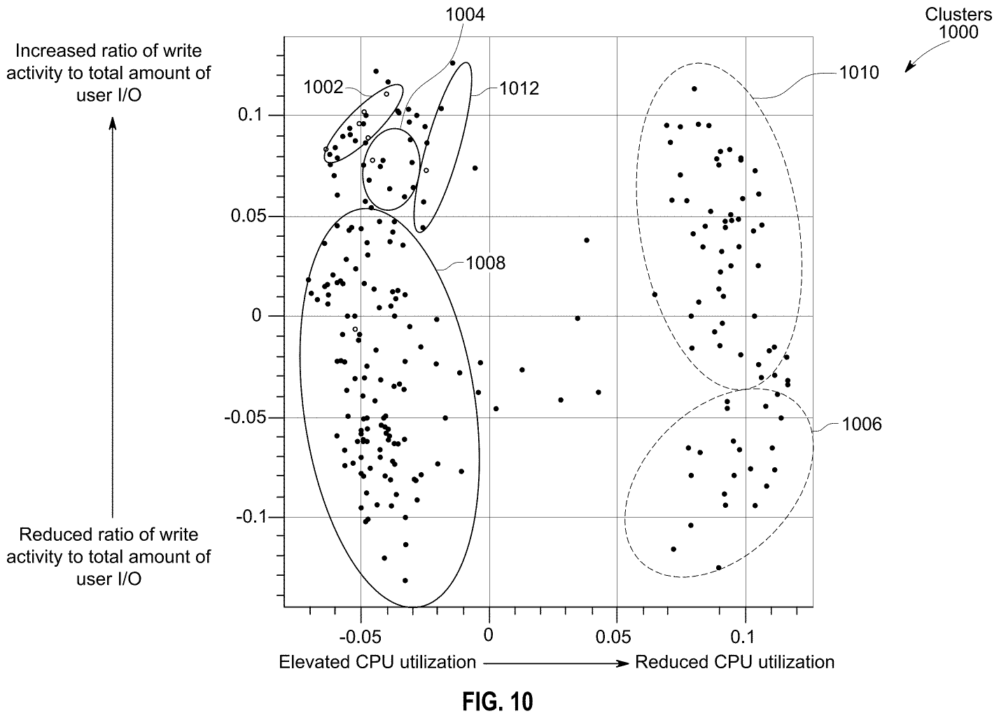

Referring again to FIG. 3, at block 310, machine-executable instructions of the incident characterization engine 106 may be executed by the hardware processors 302 to cause the incident characterization engine 102 to characterize the anomalous event based on an initial clustering of previously identified anomalous events. FIG. 10 depicts an example set of clusters 1000 of anomalous events, where each cluster represents a different category of anomalous application behavior. In some embodiments, the axes of the chart in FIG. 10 represent the first two dimensions from an independent component analysis that includes around twenty dimensions. At a high level, the left side of the chart in FIG. 10 represents elevated CPU utilization, while the right side of the chart represents reduced CPU utilization. Similarly, with respect to the y-axis, the top portion of the chart represents increased write activity in relation to total user I/O, while the bottom portion of the chart represents reduced write activity in relation to total user I/O.

In some embodiments, example clusters may include a cluster representing expected write-heavy workloads that are missing, a cluster representing expected read-heavy workloads that are missing, a cluster representing unexpected write-heavy workloads, a cluster representing unexpected read-heavy workloads, a cluster representing unexpected extended copy (xcopy) workloads, or a cluster representing potential ransomware attacks. In particular, clusters 1002, 1004, 1008, and 1012 may represent unexpected workloads such as unexpected read/write activity, while clusters 1006 and 1010 may indicate expected workloads that are missing such as expected read/write activity that is missing. More specifically, cluster 1006 may represent an expected write-heavy workload that is missing and cluster 1010 may represent an expected read-heavy workload that is missing. On the other hand, cluster 1002 may represent possible ransomware attack candidates, cluster 1004 may represent unexpected write-heavy workloads, cluster 1012 may represent unexpected xcopy workload, and cluster 1008 may represent unexpected read-heavy workload. Characterizing the anomalous event into a particular cluster may indicate an appropriate descriptor for the anomalous event. Further, in some embodiments, trained classifiers can be used to further augment the description of the anomalous event.

Referring again to FIG. 3, at block 314, machine-executable instructions of the entity identification engine 108 may be executed by the hardware processors 302 to cause the entity identification engine 108 to identify one or more entities participating in the anomalous event. In particular, the entity identification engine 108 may receive characterized anomalous event data 214 as input, and may proceed to identify one or more participating entities associated with the anomalous event. As a non-limiting example, a participating entity may be, for example, a storage volume, storage array, or the like that is associated with unexpected read/write activity. The entity identification engine 108 may generate entity participant data 216 indicating that identified participating entities.

Then, at block 316, machine-executable instructions of the narrative generation engine 110 may be executed by the hardware processors 302 to cause the narrative generation engine 110 to generate a narrative description of the anomalous event. In particular, the narrative generation engine 110 may receive the characterized anomalous event data 214 and the entity participant data 216 as input and apply a set of messaging rules 206 to the input data to generate an actionable narrative 218. At block 318, machine-executable instructions of the narrative generation engine 110 may be executed by the hardware processors 302 to cause the actionable narrative 218 to presented to an end user. In some embodiments, the actionable narrative 218 is a narrative card that is displayed via a user interface accessible by an end user.

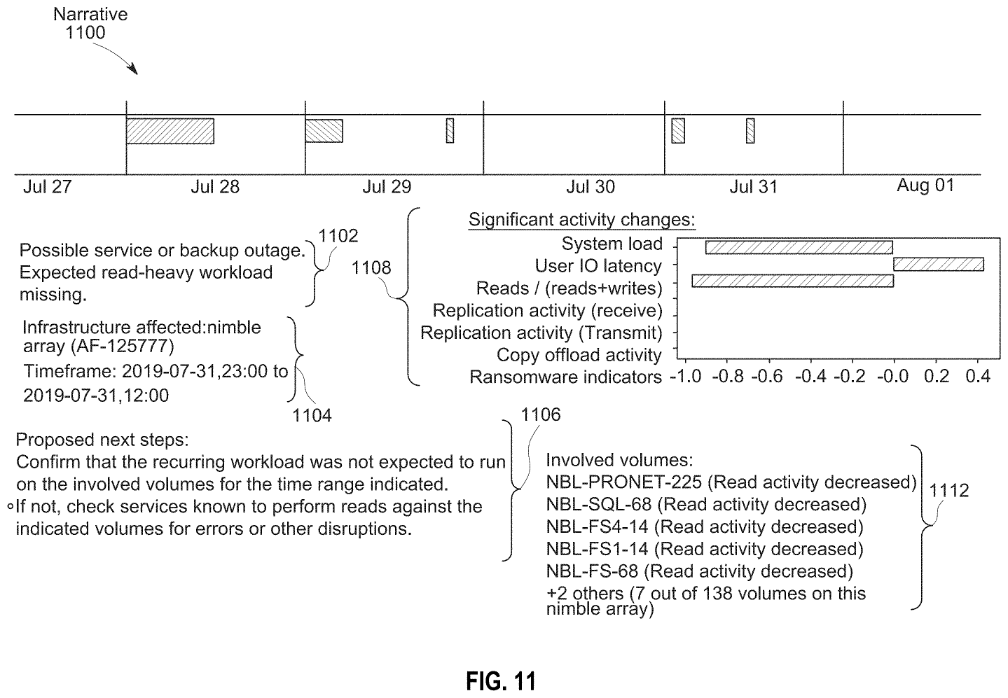

FIG. 11 depicts an example narrative description 1100 in accordance with example embodiments of the disclosed technology. In example embodiments, the narrative description 1100 includes a timeline that graphically illustrates the boundaries of the anomalous event as well as the particular time slices during which the anomalous event occurred. The narrative description 1100 further includes a section 1102 that identifies the characterization of the anomalous event (e.g., expected read-heavy workload missing) as well as a predicted cause for the anomalous event (e.g., possible service or backup outage). The narrative 1100 may further include an indication 1104 of the infrastructure affected by the anomalous event, an indication 1106 of proposed steps to take to further investigate/resolve/mitigate the anomalous event, an indication 1108 of significant activity changes associated with the anomalous event, and an indication 1112 of the entities participating in the anomalous event. Further, in some embodiments, the historical time series data 204 and/or the time series data 202 and comparisons there between them may also be presented as part of the narrative 1100.

In some embodiments, various widgets (not shown) may be displayed within the user interface in which the narrative 1100 is presented. The widgets may be selectable by an end user to provide user feedback relating to the relevancy of the narrative 1100, and in particular, the anomalous event identified in the narrative 1100. In some embodiments, the selectable widgets may correspond to predetermined types of feedback including, for example, a widget to indicate that the end user did not understand the significance of the narrative, a widget to indicate that the end user understood the narrative and found it to be useful, and a widget to indicate that the end user understood the narrative but did not find it to be useful. In some embodiments, the end user may be given the option of providing freeform user feedback or selecting from a broader scope of predefined user feedback options. It should be appreciated that the above examples of types of user feedback are merely illustrative and not exhaustive.

In example embodiments, the user feedback data may be used to refine the predicted cause for an anomalous event. For instance, the user feedback data may be used to train an ML classifier to determine predicted causes for anomalous events. In some cases, the ML classifier may over time refine/augment the predicted causes identified for anomalous events. Further, in some embodiments, the user feedback data may be used to train an ML classifier to classify the importance of an anomalous event such that only those anomalous events that are of sufficient importance to the end user are reported.

In some embodiments, the anomaly detection system (e.g., the example computer system 1300) may take automatic remedial action in response to a detected and corroborated anomalous event. Such automatic remedial action may be taken in lieu of or in addition to generating and/or presenting the narrative 110 to an end user. The automatic remedial action that is taken may vary based on the type of anomalous event that is detected. For example, upon detecting a likely ransomware attack, the anomaly detection system may signal a storage device or backup service to alter its protocol with respect to backups including, without limitation, retaining snapshots and other backups for a longer period of time that what is typically done, requiring a “cool-off” period before deleting any backups, etc. As another non-limiting example, in response to a likely ransomware attack, the anomaly detection system may signal a storage device or a backup service to quarantine particular hosts to prevent them from writing data to one or more storage devices. In the case of a system outage (e.g., the absence of expected system/application behavior), the anomaly detection system may signal a host or application to perform a failover to a backup instance of the host or application to restore service function. In the case of previously unidentified system activity being detected, where the new activity is impacting expected system workloads, the anomaly detection system may signal a storage device, host, or application to throttle resource consumption of the workload until an end user review of the source of the activity is completed. Throttling resource consumption may include, without limitation, throttling I/O, CPU activity, or the like with respect to the new workload. It should be appreciated that the above examples of automatic remedial measures that may be taken in response to various types of anomalous events are merely illustrative and not exhaustive.

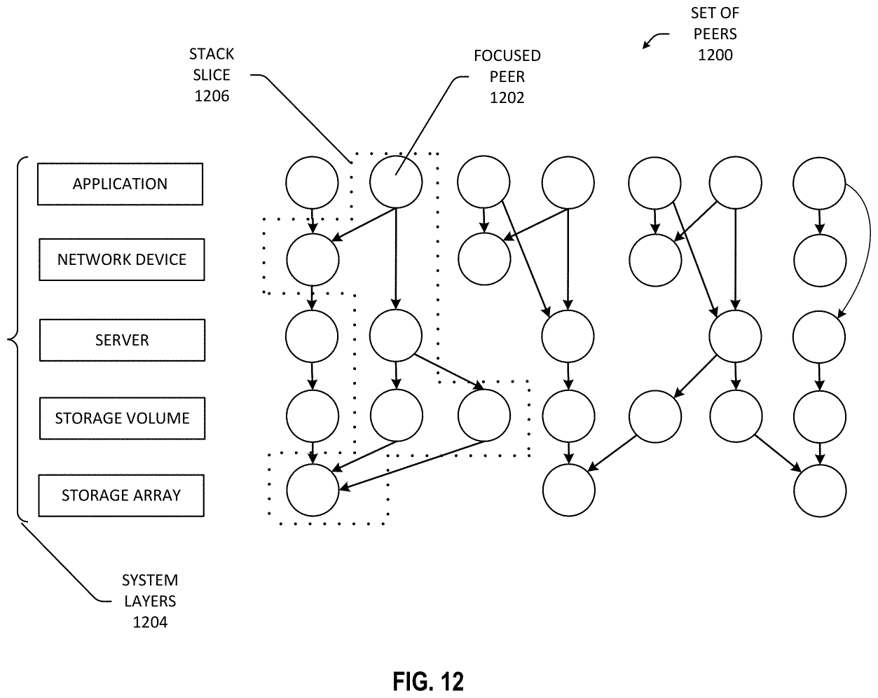

FIG. 12 schematically depicts performing anomaly corroboration processing on a stack slice that includes IT entities at multiple system layers according to example embodiments of the disclosed technology. FIG. 12 depicts a set of IT entities across various layers 1204 of a computing system/environment. In example embodiments, a focused entity 1202 may be selected and the multivariate analysis described herein may be performed with respect to a stack slice 1206 that includes entities across the multiple layers 1204. In this manner, anomalous events observed at application layer, for example, can be correlated to anomalous events in lower layers (e.g., kernel, hardware level, etc.).

FIG. 13 depicts a block diagram of an example computer system 1300 in which various of the embodiments described herein may be implemented. The computer system 1300 includes a bus 1302 or other communication mechanism for communicating information, one or more hardware processors 1304 coupled with bus 1302 for processing information. Hardware processor(s) 1304 may be, for example, one or more general purpose microprocessors.

The computer system 1300 also includes a main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. Such instructions, when stored in storage media accessible to processor 1304, render computer system 1300 into a special-purpose machine that is customized to perform the operations specified in the instructions.

The computer system 1300 further includes a read only memory (ROM) 1308 or other static storage device coupled to bus 1302 for storing static information and instructions for processor 1304. A storage device 1310, such as a magnetic disk, optical disk, or USB thumb drive (Flash drive), etc., is provided and coupled to bus 1302 for storing information and instructions.

The computer system 1300 may be coupled via bus 1302 to a display 1312, such as a liquid crystal display (LCD) (or touch screen), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. In some embodiments, the same direction information and command selections as cursor control may be implemented via receiving touches on a touch screen without a cursor.

The computing system 1300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor(s) 1304 executing one or more sequences of one or more instructions contained in main memory 1306. Such instructions may be read into main memory 1306 from another storage medium, such as storage device 1310. Execution of the sequences of instructions contained in main memory 1306 causes processor(s) 1304 to perform the process steps described herein. In alternative embodiments, hard-wired circuitry may be used in place of or in combination with software instructions.

The term “non-transitory media,” and similar terms such as machine-readable storage media, as used herein, refers to any media that store data and/or instructions that cause a machine to operate in a specific fashion. Such non-transitory media may comprise non-volatile media and/or volatile media. Non-volatile media includes, for example, optical or magnetic disks, such as storage device 1310. Volatile media includes dynamic memory, such as main memory 1306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1302. Transmission media can also take the form of acoustic or light waves, such as those generated during radio-wave and infra-red data communications.

The computer system 1300 also includes a communication interface 1318 coupled to bus 1302. Communication interface 1318 provides a two-way data communication coupling to one or more network links that are connected to one or more local networks. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN (or WAN component to communicated with a WAN). Wireless links may also be implemented. In any such implementation, communication interface 1318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1318, which carry the digital data to and from computer system 1300, are example forms of transmission media.

The computer system 1300 can send messages and receive data, including program code, through the network(s), network link and communication interface 1318. In the Internet example, a server might transmit a requested code for an application program through the Internet, the ISP, the local network and the communication interface 1318.

The received code may be executed by processor 1304 as it is received, and/or stored in storage device 1310, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1300.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method, comprising:
capturing raw sensor data using a plurality of sensors configured to monitor information technology (IT) metrics within a computing environment;
identifying, based on a univariate metric analysis of the raw sensor data, anomalous signals individually associated with the IT metrics, the anomalous signals being indicative of potentially anomalous activity within the computing environment;
corroborating, based on a multivariate metric analysis of the raw sensor data and in response to automated triggering criteria, the anomalous signals across groupings of the IT metrics to identify an anomalous event;
characterizing the anomalous event; and
applying a set of messaging rules to construct a narrative message of the anomalous event.

2. The computer-implemented method of claim 1, wherein the raw sensor data comprises current metric data relating to the IT metrics, the current metric data corresponding to a first time period wherein identifying the anomalous signals, the method further comprising:
retrieving historical metric data relating to the IT metrics, the historical metric data corresponding to one or more time periods prior to the first time period; and
comparing the current metric data to the historical metric data to identify the anomalous signals.

3. The computer-implemented method of claim 2, wherein comparing the current metric data to the historical metric data to identify the anomalous signals comprises determining that a value of an IT metric exceeds a respective threshold during the first time period and does not exceed the respective threshold during a threshold number of the one or more prior time periods.

4. The computer-implemented method of claim 2, wherein the first time period and the one or more prior time periods have a same periodicity.

5. The computer-implemented method of claim 1, wherein each anomalous signal corresponds to a different IT metric, and wherein corroborating the anomalous signals comprises:
identifying a threshold number of trigger events specified by the automated triggering criteria; and
determining that a number of the anomalous signals meets or exceeds the threshold number of trigger events.

6. The computer-implemented method of claim 1, wherein each anomalous signal corresponds to a different IT metric, and wherein corroborating the anomalous signals comprises:
determining, with respect to each anomalous signal, a respective deviation between an observed value of a corresponding IT metric and an expected value of the corresponding IT metric;
determining that each respective deviation exceeds a first threshold value;
summing the respective deviations to obtain a cumulative deviation; and
determining that the cumulative deviation exceeds a second threshold value.

7. The computer-implemented method of claim 1, further comprising:
determining boundaries of the anomalous event prior to characterizing the anomalous event, wherein determining the boundaries comprises determining a time period over which the anomalous event occurred.

8. The computer-implemented method of claim 7, wherein determining the time period over which the anomalous event occurred comprises:
determining that multiple anomalies occurred within a threshold temporal distance of each other;
determining that the multiple anomalies together constitute the anomalous event;
selecting a time period over which the multiple anomalies occurred as the time period over which the anomalous event occurred.

9. The computer-implemented method of claim 1, wherein characterizing the anomalous event comprises characterizing the anomalous event into a particular cluster group of a set of previously identified cluster groups of incidents, and wherein the narrative message comprises an identification of the particular cluster group.

10. The computer-implemented method of claim 1, further comprising determining a particular grouping of the IT metrics, wherein determining the particular grouping of the IT metrics comprises:
determining a collection of IT metrics that measure similar application behavior based on the each IT metric in the collection being associated with a same metadata tag; and
selecting a representative IT metric from the collection for inclusion in the particular grouping of IT metrics.

11. The computer-implemented method of claim 1, further comprising:
determining one or more computing entities associated with the anomalous event,
wherein the narrative message further comprises an identification of the one or more computing entities.

12. The computer-implemented method of claim 1, wherein the narrative message comprises an indication of a predicted cause for the anomalous event, the method further comprising:
receiving user feedback data indicative of relevance of historical narrative messages presented to end users; and
refining the predicted cause for the anomalous event based on the user feedback data.

13. The computer-implemented method of claim 1, wherein the anomalous event is a likely ransomware attack, the method further comprising:
instructing a storage device or a backup service to perform at least one of: i) retain a backup for a longer period of time, ii) require a cool-off period before deletion of the backup, or iii) quarantine a host to prevent the host from writing data to the storage device.

14. The computer-implemented method of claim 1, wherein the anomalous event is a system activity outage, the method further comprising:
instructing a host or an application to failover to a backup instance of the host or the application to restore service function.

15. The computer-implemented method of claim 1, wherein the anomalous event is previously unidentified new system activity that is impacting expected system workloads, the method further comprising:
instructing a storage device, a host, or an application to throttle resource consumption of the new system activity for a specified period of time.

16. A system, comprising:
a memory storing machine-executable instructions; and
a processor configured to access the memory and execute the machine-executable instructions to:
identify, from metric data relating to a set of metrics representative of activity within a computing environment, anomalous signals indicating that a portion of the activity is potentially anomalous;
corroborate the anomalous signals across groupings of metrics within the set of metrics to identify an anomalous event;
characterize the anomalous event;
identify one or more participating entities within the computing environment that are associated with the anomalous event; and
generate a narrative message of the anomalous event, the narrative message including an identification of the characterization of the anomalous event and an indication of the one or more participating entities.

17. The system of claim 16, wherein the at least one processor is further configured to execute the computer-executable instructions to:
predict a cause of the anomalous event,
wherein the narrative message includes an indication of the predicted cause.

18. The system of claim 17, wherein the at least one processor is configured to identify the anomalous signals by executing the computer-executable instructions to:
collect the metric data from one or more sensors, wherein the metric data corresponds to a first time period;
retrieve historical metric data relating to the set of metrics, the historical metric data corresponding to one or more time periods prior to the first time period; and
compare the metric data to the historical metric data to identify the anomalous signals.

19. A computer program product comprising a non-transitory computer readable medium storing program instructions that, when executed by a processor, cause operations to be performed comprising:
capturing sensor data using a plurality of sensors configured to monitor activity within a computing environment, the raw sensor data relating to a set of metrics that characterize aspects of the activity;
identifying, based on a univariate analysis of the sensor data, anomalous signals indicating that a portion of the activity is potentially anomalous;
corroborating, based on a multivariate analysis of the sensor data, the anomalous signals across groupings of metrics within the set of metrics to identify an anomalous event;
characterizing the anomalous event; and
generating a narrative analysis of the anomalous event.

20. The computer program product of claim 19, wherein presenting the narrative analysis to the end user comprises:
populating, based on a set of messaging rules, predefined fields of a narrative card template with information indicative of the narrative analysis of the anomalous event to obtain a customized narrative card for the anomalous event; and
presenting the customized narrative card to the end user via a user interface configured to receive and display the customized narrative card.
